(19) United States
(12) Patent Application Publication
(10) Pub. No.: US 2007/0260875 A1
(43) Pub. Date: Nov. 8, 2007

(54) Method and apparatus for preferred business partner access in public wireless local area networks (LANS)

(75) Inventors: Mandayam Thondanur Raghunath, Fishkill, NY (US); Dinesh Chandra Verma, Mount Kisco, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/418,076

(22) Filed: May 5, 2006

(51) Int. Cl. H04L 9/00

(52) U.S. Cl. 713/156

(57) ABSTRACT

A method (and system) of providing preferred access to a service includes linking an authorization server of a service provider with a certification scheme provided by a business enterprise.

### BACKGROUND OF THE INVENTION

1. Field of the Invention

The present invention generally relates to a method and apparatus for identifying and verifying attributes of identification credentials, and more particularly to a method and apparatus that allows a service provider to identify and verify identification credentials of an individual employee to determine if the employee is a member of a certain enterprise.

2. Description of the Related Art

Public wireless local area network (LAN) access is offered by many hotels, airports and businesses. In a typical public wireless LAN offering in a hotel, a hotel charges its guests a fixed amount (e.g., $10 per day) for 24 hour wireless access. The hotels typically outsource the operation and administration of the wireless LAN access to a service provider for support and service of the LAN.

Many large enterprises establish business agreements with hotel chains. As a result of the business agreements, the enterprises often obtain preferential wireless access for visitors of the hotel from the enterprise. For example, when an employee of the business enterprise travels to a hotel, with which the enterprise has established a business agreement, the employee may pay a reduced fee for wireless access or the employee may receive access to a higher grade of service (e.g., a service allowing for unrestricted UDP access instead of only web-access) for no additional charge.

When accessing the wireless LAN infrastructure at the hotel (or airport, business, etc.), the preferred access is only given to authorized users who belong to the business enterprise that established the business agreement. However, the employees' authorization/identification credentials are typically with the business enterprise and cannot be shared with the hotel or wireless LAN service provider.

Several conventional techniques have been developed for providing preferential access to authorized users. One known technique indicates the category of a traveler in the room record, and charges the traveler differently on the basis of the room-rate provided. However, this requires that the wireless access be tied into the hotel reservation records. Also, in certain business partner relationships, such a database is not available at all. For example, in the context of a business such as Starbucks® or at an airport, there is no such database that can be used to store the properties of the person accessing the wireless LAN.

Another known technique charges the customer at the standard rate and then issues the customer a credit using a rebate mechanism. This process is slow and can be tedious for the business enterprise. Furthermore, this process may not enable customers to obtain a higher grade of service automatically.

Certain conventional techniques have the service provider issue unique identities/credentials to each employee of the business enterprise. However, this requires additional management overhead on the part of the service provider.

Some web sites offer free access to online books and journals to all employees of a particular company. The company's employees access the online books by logging on to a company website, which then redirects the user to the online library. The online library allows the user to access resources because it knows that the request came from the company website with which the online library has established an agreement.

The employee first accesses the employer's website and authenticates to this website, so that the credentials are exchanged directly between the issuer and the user. Alternatively, the service provider may issue special credentials to the individual users. At the point of service access, the service provider verifies the user's membership in the enterprise and issues a separate credential. The user has to present the separate credential to the service provider when he requests the service. This technique requires a higher degree of overhead in terms of management and an additional set of credentials.

In general, the service provider is an untrusted intermediary, in that the service requestor typically does not want to reveal the identification credentials that pertain to the enterprise. In other words, the service requester (e.g., the employee of the enterprise) does not want to divulge to the service provider a password or other credential that the service requester has established with the enterprise. Thus, it is important that the technique maintains the anonymity of the service requester. Unlike the library access situation, where direct connectivity exists between the service requestor and the enterprise, service requesters for public wireless LANs can not create an independent connection to the enterprise because usually the only means for connectivity is through the service provider's LAN. Therefore, a method by which the service requestor can authenticate itself to the enterprise directly ca not be used.

### SUMMARY OF THE INVENTION

In view of the foregoing and other exemplary problems, drawbacks, and disadvantages of the conventional methods and structures, an exemplary feature of the present invention is to provide a method and structure in which a service provider may identify and verify identification credentials of an individual employee to determine if the employee is a member of a certain group, without revealing the identification credentials to the service provider.

In accordance with a first exemplary aspect of the present invention, a method of providing preferred access to a service includes linking an authorization server of a service provider with a certification scheme provided by a business enterprise.

In accordance with a second exemplary aspect of the present invention a method of providing preferred access to a service includes receiving an access request from a user, requesting the user to prove that the user is authorized by a business enterprise to obtain preferred access to the service, and validating proof of authorization provided by the user.

In accordance with a third aspect of the present invention, a system for providing preferred access to a service includes a linking unit that links an authorization server of a service provider with a certification scheme provided by a business enterprise.

In accordance with a fourth aspect of the present invention, a signal-bearing medium tangibly embodies a program of machine readable instructions executable by a digital processing apparatus to perform a method of providing preferred access to a service. The method includes linking an authorization server of a service provider with a certification scheme provided by a business enterprise.

In accordance with a fifth aspect of the present invention, a method of deploying computing infrastructure, includes integrating computer-readable code into a computing system, wherein the computer readable code in combination with the computing system is capable of performing a method of providing preferred access to a service. The method of providing preferred access to a service includes linking an authorization server of a service provider with a certification scheme provided by a business enterprise.

Employees of the business enterprise are authorized for preferred access to the service by existing credentials maintained on a network of the business enterprise. The credentials are certified by the enterprise to the authorization server. The authorization server can use the credentials to determine the appropriate category of service provider for the employee and use this information to provide, if appropriate, the preferred service.

It is important that the identification/security credentials of the employee of the business enterprise remain confidential. The method (and system) of the present invention uses the identification credentials issued by the business enterprise to establish authenticity, while never revealing the credentials to the service provider. Thus, the service provider knows that the user is a member of the business enterprise, but does not know exactly who the user is. Additionally, no further credential management/identity management solution is needed. Furthermore, the establishment of preferred access is done in near real-time and is instantaneous, as opposed to methods that provide subsequent credit.

Another advantage of the present invention is that no separate credentials need to be generated for obtaining preferred access from external service providers. Issuing and managing credentials is an expensive procedure, and maintaining a single set of credentials is more cost effective.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 depicts a flow diagram of a method 100 of providing preferred access to a service in accordance with an exemplary embodiment of the present invention;

FIG. 2 illustrates a schematic diagram of a system 200 for providing preferred access to a service in accordance with an exemplary embodiment of the present invention;

FIG. 3 depicts a flow diagram of a method 300 of providing preferred access to a service in accordance with the exemplary embodiment depicted in FIG. 2;

FIG. 4 illustrates a system for providing preferred access to a service in accordance with an exemplary embodiment of the present invention;

FIG. 5 illustrates a block diagram of the environment and configuration of an exemplary system 500 for incorporating the present invention; and

FIG. 6 illustrates a storage medium 600 for storing steps of the program for scaling a binary image according to the present invention.

### DETAILED DESCRIPTION OF EXEMPLARY EMBODIMENTS OF THE INVENTION

In accordance with certain exemplary aspects of the present invention, an end user (e.g., service requestor) requests service from a service provider, who operates and administers a service for a premises organization, and indicates to the service provider that the requestor is a member of a particular organization (e.g., business enterprise). The premises organization and the business enterprise have a predetermined business relationship that entitles the members of the business enterprise to preferred access to a service provided by the service provider.

When the user requests service, the service provider must first verify the authenticity of the user before enabling the user to use the service. The service provider contacts the enterprise, which prepares a challenge that the service provider sends to the user. The user responds to the challenge and sends it back to the service provider, who forwards it to the enterprise for validation.

In the discussion of certain exemplary embodiments of the invention discussed below, the “premises organization” is, for example, a hotel that provides a public wireless LAN to its guest. The public wireless LAN is operated and maintained by the service provider. The hotel outsources the operation and administration of the LAN to the service provider. The “enterprise” refers to any entity that has established a business agreement with the hotel (or other business). The “user” refers to a member (e.g., an employee) of the enterprise.

However, these definitions are merely provided for exemplary purposes and are not meant to limit the scope of the present invention.

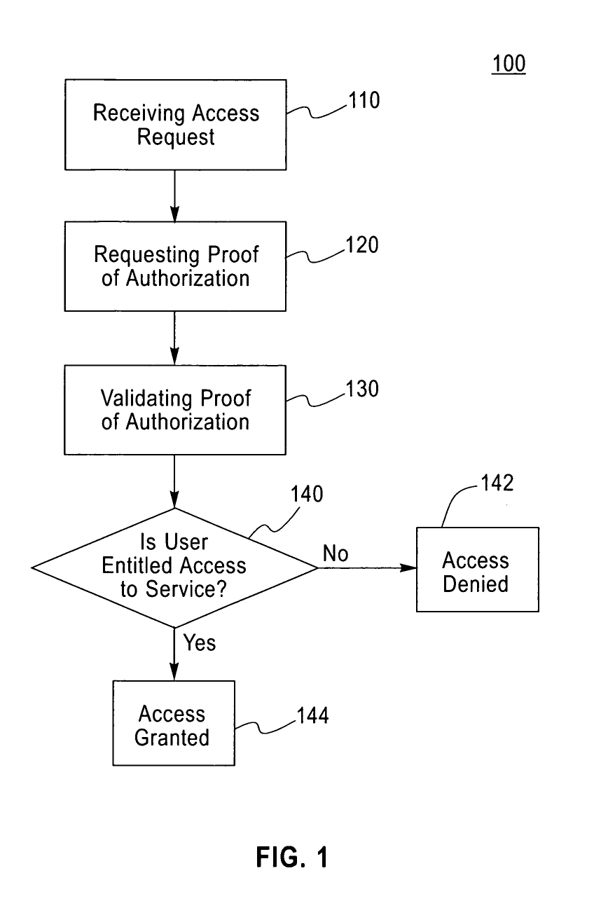

Referring now to the drawings, and more particularly to FIGS. 1-6, there are shown exemplary embodiments of the method and structures according to the present invention.

FIG. 1 illustrates a method 100 for providing preferred access to a service in accordance with an exemplary embodiment of the present invention.

The method 100 includes linking an authorization server of a service provider with a certification scheme provided by the business enterprise. The authentication/authorization server receives a preferred access request from a user (step 110).

The authorization server then requests the user to provide proof of authorization to obtain preferred access (step 120). As indicated above, only certain users (e.g., members of an enterprise that has established a business relationship with the premises organization) are entitled to preferred access. Thus, the user must provide proof that the user is a member of the business enterprise.

Once the user provides proof of authorization, the authorization server of the service provider validates the proof of authorization (step 130). If the proof is validated (step 140), then the user is deemed entitled to preferred access and access is automatically granted (step 144).

If the proof is not valid (step 140), then preferred access is denied (step 142). If preferred access is denied (step 142), then the user requesting access may choose to withdraw the access request or request standard access to the service.

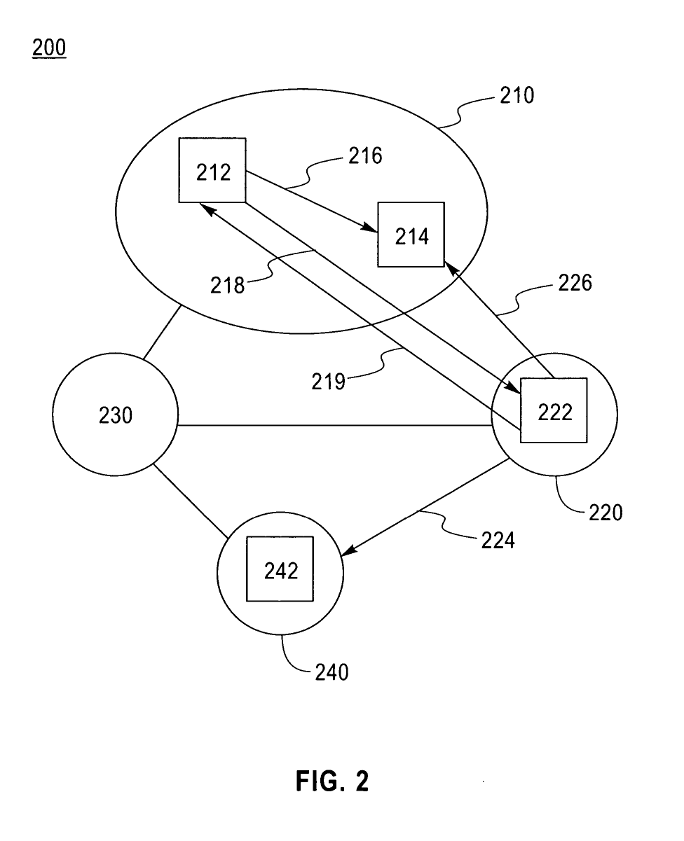

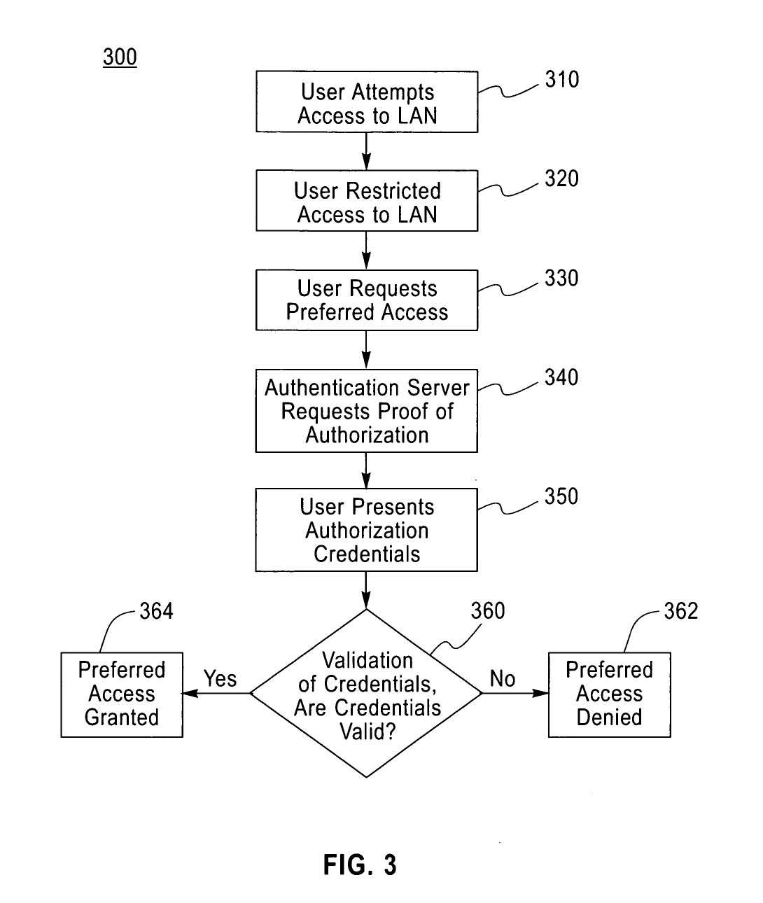

FIGS. 2 and 3 provide a detailed explanation of certain exemplary embodiments of the invention in reference to the specific example of public wireless LAN access.

For purposes of the following description, the provisioning of wireless access involves three organizations, including the premises organization, the wireless service provider and the enterprise. FIG. 2 illustrates the relationships between the premises organization 210, the wireless service provider 220 and the enterprise 240. The premises organization 210, the wireless service provider 220 and the enterprise 240 are connected by a network such as by the internet 230.

The wireless service provider 220 is responsible for operating the wireless access point 214 that is located at the facilities of the premises organization 210 (e.g., the hotel). The user (e.g., employee of the enterprise 240) is located at the premises organization 210. The user powers a mobile device (e.g., laptop computer) 212 and accesses the dynamic host configuration protocol (DHCP) server (e.g., illustrated by arrow 216) at the access point 214, which is operated by the wireless service provider 220.

The wireless device 212 attempts to obtain a dynamic access from the LAN that is operated using the DHCP server. The initial address allocation restricts the user to access only an authorization server 222 operated by the wireless service provider 220. This restriction may be enforced, for example, by setting routing policies at a router that is under the administrative control of the wireless service provider 220.

The authorization server 222 then asks the user to select the type of service required (e.g., illustrated by arrow 218) and specify the billing information (e.g., the hotel room number, credit card information or receipt number from the premises organization 210). The authorization server 222 then authorizes the IP address of the wireless device 212 for access at the type of service requested (e.g., illustrated by arrow 219).

The above steps will be carried out whether or not a user requests preferred access. That is, any user requesting any access to the public LAN will use the basic process described above. In the situation where the user requests preferred access, this basic process may be augmented by the following steps.

The authorization server 222 asks the user to prove that the user is authorized to gain preferred access. That is, the user must prove that he is an authorized member (e.g., employee) of the enterprise 240. The user proves authorization by presenting credentials that have been issued to the user by the enterprise 240. The authorization server 222 then validates the credentials with a validation server 242 that is operated by the enterprise 240. If the validation server 242 validates the credentials, then the authentication server sets the filter in the access router so that the user's mobile device 212 can access the network at the preferred rates/class of service, in accordance with the agreement established between the premises organization 210 and the business enterprise 240.

An exemplary method for authenticating the user's credentials is by having a user id/password or a certificate issued to the user. The mobile device 212 includes software that can take the user id/password and sign it using a public key of the validation server 242. The authentication server 222 provides a salt and time-of-day (e.g., time stamp) to the mobile device 212 (e.g., illustrated by arrow 219). The software on the mobile device 212 encrypts the salt, time-of-day and the user id/password using the public key of the validation server 242 (e.g., illustrated by arrow 218).

The resulting digital contents are presented to the authorization server 222, which then takes them to the enterprise's validation server 242 (e.g., illustrated by arrow 224). The validation server 242 decrypts the digital content with a private key, validates the user id/password of the user and presents the salt and time-of-day back to the authorization server 222. On receiving the information from the validation server 242, the authorization server 222 can then set the appropriate filters on the routers at the access point 214 (e.g., illustrated by arrow 226).

Since the validation server 242 of the enterprise decrypts the digital content using a private key, as opposed to the authorization server decrypting the digital content, the anonymity of the user is maintained.

FIG. 3 illustrates a flow diagram of the method 300 of providing preferred access to a service by linking an authorization server of the service provider with a certification scheme provided by the business enterprise in accordance with the exemplary embodiment detailed in FIG. 2 above.

First, a user attempts to access the public LAN (step 310). The user, however, is restricted access to the LAN (step 320). The user then requests a level of access (e.g., preferred access) (step 330). The authentication server requests proof that the user is authorized to receive the requested level of access (step 340). Then, the user presents authorization credentials to the authentication server (step 350). The authentication server then determines whether the credentials presented are valid (step 360). If the credentials presented by the user are not valid, then the user is denied the requested access (step 362). If the credentials presented by the user are valid, then the user is granted the requested access (step 364).

The entire system 200 and method 300 depicted in FIGS. 2 and 3 can be implemented using a web-based authentication server, which contains the encryption software as a Java® applet/Javascript program. The applet/program can be signed by the enterprise 240 to provide assurances of the integrity of program.

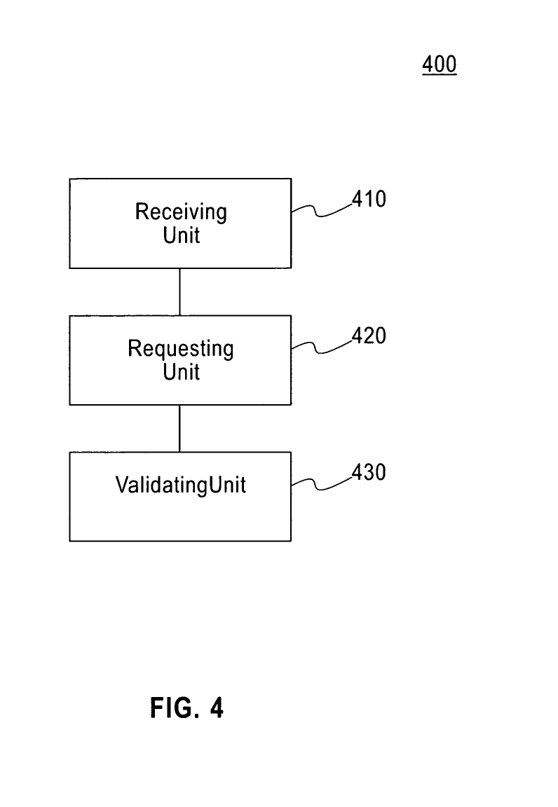

FIG. 4 depicts a system 400 for providing preferred access to a service by linking an authorization server of the service provider with a certification scheme provided by the business enterprise in accordance with certain exemplary embodiments of the present invention. The system 400 at least includes a receiving unit 410, a requesting unit 420 and a validating unit 430.

The receiving unit 410 receives an access request from a user. The requesting unit 420 requests the user to prove that the user is authorized by the business enterprise to obtain preferred access to the service. The validating unit 430 validates proof of authorization provided by the user.

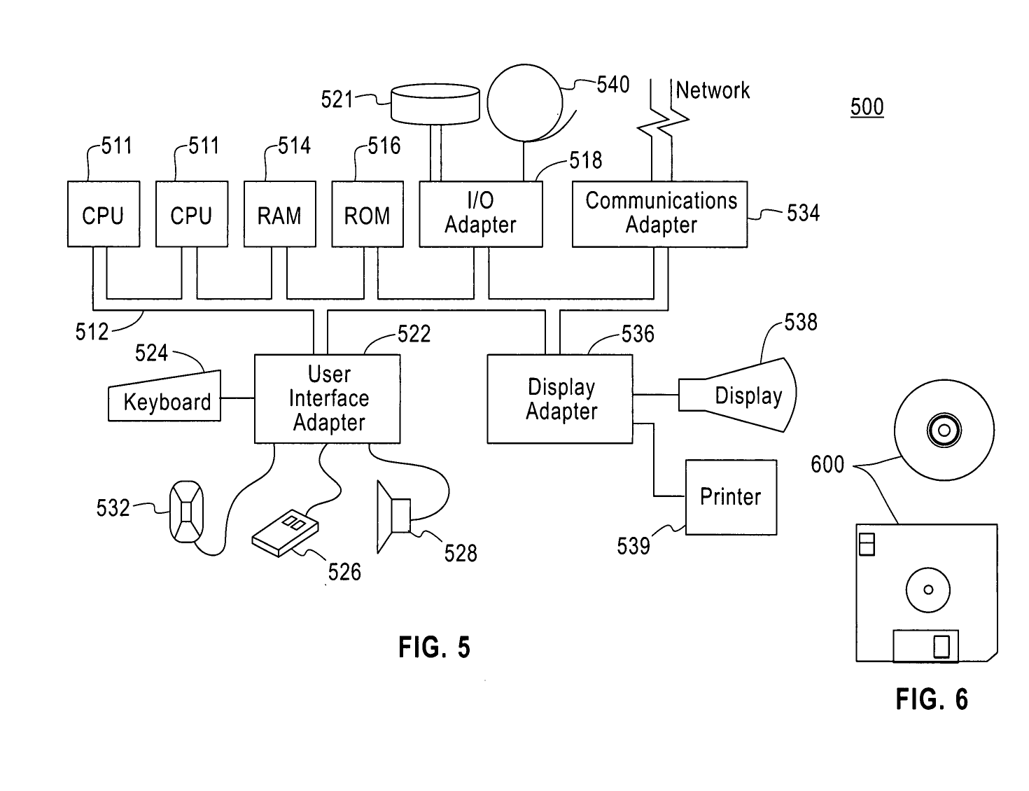

FIG. 5 shows a typical hardware configuration of an information handling/computer system in accordance with the invention that preferably has at least one processor or central processing unit (CPU) 511. The CPUs 511 are interconnected via a system bus 512 to a random access memory (RAM) 514, read-only memory (ROM) 516, input/output adapter (I/O) 518 (for connecting peripheral devices such as disk units 521 and tape drives 540 to the bus 512), user interface adapter 522 (for connecting a keyboard 524, mouse 526, speaker 528, microphone 532, and/or other user interface devices to the bus 512), communication adapter 534 (for connecting an information handling system to a data processing network, the Internet, an Intranet, a personal area network (PAN), etc.), and a display adapter 536 for connecting the bus 512 to a display device 538 and/or printer 539 (e.g., a digital printer or the like).

As shown in FIG. 5, in addition to the hardware and process environment described above, a different aspect of the invention includes a computer implemented method of performing the inventive method. As an example, this method may be implemented in the particular hardware environment discussed above.

Such a method may be implemented, for example, by operating a computer, as embodied by a digital data processing apparatus to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 511 and hardware above, to perform the method of the present invention.

This signal-bearing media may include, for example, a RAM (not shown) contained with the CPU 511, as represented by the fast-access storage, for example. Alternatively, the instructions may be contained in another signal-bearing media, such as a magnetic data storage diskette or CD disk 600 (FIG. 6), directly or indirectly accessible by the CPU 511.

Whether contained in the diskette 600, the computer/CPU 511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc), or other suitable signal-bearing media including transmission media such as digital and analog and communication links and wireless. In an illustrative embodiment of the invention, the machine-readable instructions may comprise software object code, compiled from a language such as “C”, etc.

Additionally, it should also be evident to one of skill in the art, after taking the present application as a whole, that the instructions for the technique described herein can be downloaded through a network interface from a remote storage facility.

The present invention has been described in reference to public wireless LANs. However, the method (and apparatus) of the present invention is not limited to this exemplary application. Indeed, the method of the present invention may applied to any application where a user presents credentials to a service provider in an attempt to gain access to the service.

For instance, consider the example where a user is issued an ID (e.g., such as a credit card) by a trusted ID issuing organization. The ID issuing organization is trusted both by the users and the service providers. The ID issuing organization may associate various attributes with the user's ID. For example, the user can prove to the issuing organization that he is an employee of a certain company, a member of AAA, a frequent flier with a certain airline, etc. The issuing organization can then verify the user's claims and include each of these as attributes associated with the particular user.

At a later point in time, when the user requests a particular service from a service provider, the user presents the ID to the service provider and indicates that the user has a certain attribute that the service provider is interested in, that the user is claiming is valid for the user whose ID is presented to the service provider. The issuing organization can confirm this and the service provider can then proceed to offer the user access to the requested service.

However, in the above example, the user is not anonymous since he presents his ID, and may also have to prove to the service provider that the ID belongs to the user. In accordance with certain exemplary aspects of the method and system of the present invention, the anonymity of the user can be maintained. That is, the user would merely state that the user has an association with the issuing organization. The service provider requests the issuing organization to present a challenge, which is sent to the user. Then, the user responds to the challenge, which the service provider verifies with the issuing organization along with the membership attributes associated with the user.

Furthermore, the service provider may have a list of attributes that enable users to obtain a lower price or a higher level of service. Instead of simply verifying the user's claim that he has a certain attribute, the service provider may query the issuing organization whether the user has one or more of the attributes on the list. The issuing organization can confirm the attributes that are on the user's record and the service provider may automatically apply the relevant discounts, while maintaining the anonymity of the user.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of providing preferred access to a service, comprising:
linking an authorization server of a service provider with a certification scheme provided by a business enterprise.

2. The method according to claim 1, further comprising:
maintaining an anonymity of a member of the business enterprise requesting access to a service provided by the service provider.

3. The method according to claim 1, further comprising:
automatically providing access to an authorized member of the business enterprise.

4. The method according to claim 1, further comprising:
validating proof of authorization provided by a user.

5. The method according to claim 4, wherein said validation is conducted through the business enterprise so that an identity of a member of the business enterprise requesting access to a service provided by the service provider is not revealed to the service provider.

6. The method according to claim 4, wherein said validating comprises:
encrypting a member identification on a member of the business enterprise's mobile device; and
decrypting the member identification on a server operated by the business enterprise.

7. The method according to claim 1, wherein a member of the business enterprise provides identification credentials to obtain preferred access to a service provided by the service provider.

8. The method according to claim 1, wherein said service comprises a public wireless local area network.

9. A method of providing preferred access to a service, comprising:
receiving an access request from a user;
requesting the user to prove that the user is authorized by a business enterprise to obtain preferred access to the service; and
validating proof of authorization provided by the user.

10. The method according to claim 9, further comprising:
maintaining an anonymity of a member of the business enterprise requesting access to a service provided by the service provider.

11. The method according to claim 9, further comprising:
automatically providing access to an authorized member of the business enterprise.

12. A system for providing preferred access to a service, comprising:
a linking unit that links an authorization server of a service provider with a certification scheme provided by a business enterprise.

13. The system according to claim 12, wherein an anonymity of a member of the business enterprise requesting access to a service provided by the service provider is maintained.

14. The system according to claim 12, further comprising:
a requesting unit that requests a user to prove that the user is authorized by the business enterprise to obtain preferred access to the service.

15. The system according to claim 14, further comprising:
a validating unit that validates proof of authorization provided by the user.

16. The system according to claim 15, wherein said validating unit maintains an anonymity of a member of the business enterprise requesting access to a service provided by the service provider.

17. A signal-bearing medium tangibly embodying a program of machine readable instructions executable by a digital processing apparatus to perform a method of providing preferred access to a service, according to claim 1.

18. A method of deploying computing infrastructure, comprising integrating computer-readable code into a computing system, wherein the computer readable code in combination with the computing system is capable of performing a method of providing preferred access to a service, according to claim 1.

19. A signal-bearing medium tangibly embodying a program of machine readable instructions executable by a digital processing apparatus to perform a method of providing preferred access to a service, according to claim 9.

20. A method of deploying computing infrastructure, comprising integrating computer-readable code into a computing system, wherein the computer readable code in combination with the computing system is capable of performing a method of providing preferred access to a service, according to claim 9.
